(19) United States
(12) Patent Application Publication
(10) Pub. No.: US 2017/0132095 A1
(43) Pub. Date: May 11, 2017

(54) DATA RESTORATION

(71) Applicant: Hewlett Packard Enterprise Development LP, Houston, TX (US)

(72) Inventor: Goetz Graefe, Madison, WI (US)

(21) Appl. No.: 15/127,468

(22) PCT Filed: Mar. 28, 2014
(86) PCT No.: PCT/US2014/032234

§ 371 Date: Sep. 20, 2016

(51) Int. Cl. G06F 11/16

(52) U.S. Cl. CPC G06F 11/1662; G06F 2201/805; G06F 2201/82; G06F 2201/85

(57) ABSTRACT

An example data restoration approach includes loading a replacement storage media upon detecting a media failure in a failed storage media, detecting a request for data originally stored on the failed storage media that is pending restoration to the replacement storage media, and in response to detecting this data request, restoring a data segment associated with the data from a backup to the replacement storage media. The approach further modifies the data segment in the replacement storage media according to archived modifications to the data segment in a log archive and then responds to the data request.

### BACKGROUND

Instead of having one large storage media, conventional data stores now employ multiple mailer storage media (e.g., hard disk, solid state drive) that store portions of the data store. When one of these storage media fails, some systems can automatically switch to a replacement storage media and begin restoring data that was originally stored on the failed storage media from a backup (e.g., tape drive).

The backups typically include a full backup, as well as incremental and/or differential backups that identify changes that have been made to the database since the full backup was taken. Additional changes to the database may be stored in a log archive that details changes since the last backup was performed, and in an active log that details changes that were made to the database that have yet to be committed to the log archive.

When a storage media fails, conventional systems typically load a full backup and store the backup to a replacement storage media, followed by replacing pages that have been updated since the full backup as indicated by incremental and/or differential backups. Next, modifications to pages identified in the log archive and active log may be performed in series by loading pages, modifying the pages in memory, and then re-storing the modified pages on the replacement storage media. As pages may have multiple log archive and active log entries, depending on how any modifications have occurred since the last backup, individual pages may be loaded and stored multiple times, which is a relatively slow process. Once all of this has been completed, the data store may finally become accessible for normal operations. However, performing restoration in this manner can take a very long time, and the data store may be inoperative while the restoration process completes.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example data store in which example systems and methods, and equivalents, may operate.

FIG. 2 illustrates a flowchart of example operations associated with data restoration.

FIG. 3 illustrates another flowchart of example operations associated with data restoration.

FIG. 4 illustrates an example system associated with data restoration.

FIG. 5 illustrates an example computing environment in which example systems and methods, and equivalents, may operate.

### DETAILED DESCRIPTION

A data restoration approach is described. When a storage media (e.g., a hard disk, solid state drive, or hybrid drive) in a system (e.g., database) fails, the system may be able to detect the failure and automatically switch to a replacement storage media. Alternatively, the switch may occur after a user (e.g., a technician) manually replaces the failed storage media. However, at the time of replacement, the replacement storage media may not yet be loaded with the data that was on the failed storage media before the failure of the failed storage media.

Thus, a restoration process may be initiated to load from a backup to the replacement storage media, data that was originally stored on the failed storage media. If the system is unable to respond to requests for the data on the failed storage media while data is being restored the replacement storage media, this may create a significant downtime in the system. Thus, when a request for data from the failed storage media device is detected, if this data has not already been restored to the replacement media, the restoration process may prioritize the requested data for restoration, after which the data request may be responded to. Consequently, when there is a replacement storage media that the system can automatically switch to, it is possible that downtime can be reduced or eliminated. While response times may be faster when the system is not restoring data from a backup (i.e., fully operational), systems and methods disclosed herein may reduce conventional downtimes that may occur while waiting for an entire replacement media to be restored from a backup.

It should be understood that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

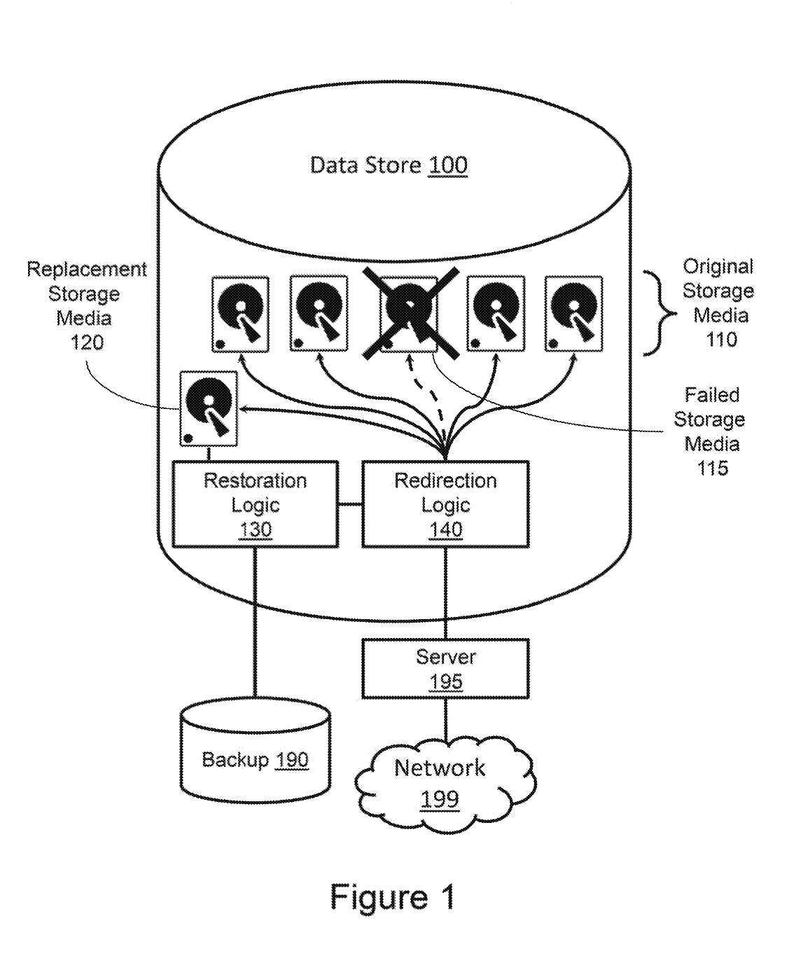

FIG. 1 illustrates an example data store 100 in which example systems and methods, and equivalents may operate. Data store 100 may be, for example, a relational database, a key value store, or some other system for storing data. Data store 100 may be connected to, for example, a server 195 which responds to requests for data received from a network 199. Network 199 may be, for example, the Internet, a local area network, a secure network, a virtual network, and other similar networks. Data store 100 may also be attached to a backup 190. Backup 190 may include, for example, full backups, differential backups, incremental backups, and so forth. A log archive of changes that have been made to the data store since the last backup may also be stored in a storage media 110, in memory (e.g., RAM), or in some other location within data store 100.

Data store 100 includes several original storage media 110 and a replacement storage media 120. The replacement storage media 120 may be a pre-installed storage media to take over the responsibilities of an original storage media 110 in the event that original storage media fails. In general, storage media may refer to hard disk drives, solid state drives, hybrid drives, and the like. Though five original storage media and one replacement storage media, are illustrated, other numbers are possible in various implementations. In fact, some data stores may have no replacement storage media pre-installed by default, and may require manual replacement of a failed storage media with a replacement storage media. Similarly, a data store may also require manual replacement of a failed storage media if all replacement storage media have been used or if there are multiple simultaneous media failures.

In this example, one of original storage media 110 has failed, turning into failed storage media 115. Conventionally, when this failure is detected, a restoration logic 130 may load all data from a backup 190 to replacement storage media 120, and then make multiple passes over the data to re-perform actions that occurred on data stored on failed storage media 115 since the backup. These actions may be indicated in differential and/or incremental backups, a log archive, an active log, and so forth. Meanwhile, the data originally stored on failed storage media 115, and possibly all of data store 100 may be inaccessible.

For example, for a backup that uses incremental backups, a conventional restoration logic 130 may restore the most recent full backup, followed by each incremental backup. This may cause conventional restoration logic 130 to potentially load pages restored to replacement storage media 120, modify the pages, and re-store the pages for each incremental backup. Conventional restoration logic 130 may then traverse a log archive and an active log, and again load, modify, and store a single data page on replacement storage media 120 for each time the page is modified in the log archive and active log. This restoration process may take a substantial amount time and lead to significant downtime of data store 100 while the data originally stored on failed storage media 115 is being recovered to replacement storage media 120.

Instead, upon detecting the failure of failed storage media 115, a redirection logic 140 may begin intercepting accesses to individual database pages that would be directed towards failed storage media 115, and begin directing them towards replacement storage media 120. Additionally, redirection logic 140 may initiate restoration logic 130. Restoration logic 130 may manage the restoration of data, originally stored on failed storage media 115 to replacement storage media 120 from backup 190. In one example, redirection logic 140 may route accesses directed at failed storage media 115 to replacement storage media 120 through restoration logic 130. This may allow restoration logic 130 to prioritize for restoration from backup 190, data that has not yet been restored to replacement storage media 120 for which there is a pending data access. Once the restoration process has been completed, redirection logic 140 may begin routing accesses directly to replacement storage media 120. During the restoration process, routing of accesses to other original storage media 110 may remain unchanged.

In one example, restoration logic 130 may employ single pass restore techniques to ensure fast restoration of data to replacement storage media 120. A single pass restore technique typically uses backups and log archives that have been sorted by device identifier and page identifier. However, if a device restores data segments of a size different than a page, an identifier associated with data segments of this different size may be appropriate instead of a page identifier. Generally, single pass restore techniques fully restore a data page to its most recent stage by combining operations associated with the page into a small number of loads and stores to replacement storage media 120.

By way of illustration, when a page is being restored, restoration logic 130 may first load into memory a most recent image of the page from a full backup on backup 190. The page in memory may then be updated according to incremental and/or differential backups that were taken since the full backup. A log archive may then be searched for further modifications associated with the page being restored, and these modifications may then be applied to the page while it is still in memory from when restoration logic 130 originally loaded the image from the full backup. Changes associated with the page in an active log and/or the buffer pool may also be applied to the page before restoration logic 130 ultimately stores the page on replacement storage media 120.

Once a page has been restored, restoration logic 130 may then begin restoring a next page from backup 190, the log archive, and so forth. Whether this next page is an arbitrary unrestored page (e.g., a next unrestored page in a sequential ordering of the pages), or a specifically selected page may depend on whether there is a pending data access associated with an unrestored page. Other factors may also be considered when selecting pages for restoration. For example, pages that are more frequently requested than other pages may be prioritized for restoration. Restoration logic 130 may be able to determine which pages are frequently requested by analyzing which pages are frequently modified in the log archive and/or the active log. Alternatively, pages that have been recently requested may be prioritized. This may be achieved by prioritizing restoration for pages associated with the failed storage media in the buffer pool. Other reasons for prioritization may also be possible.

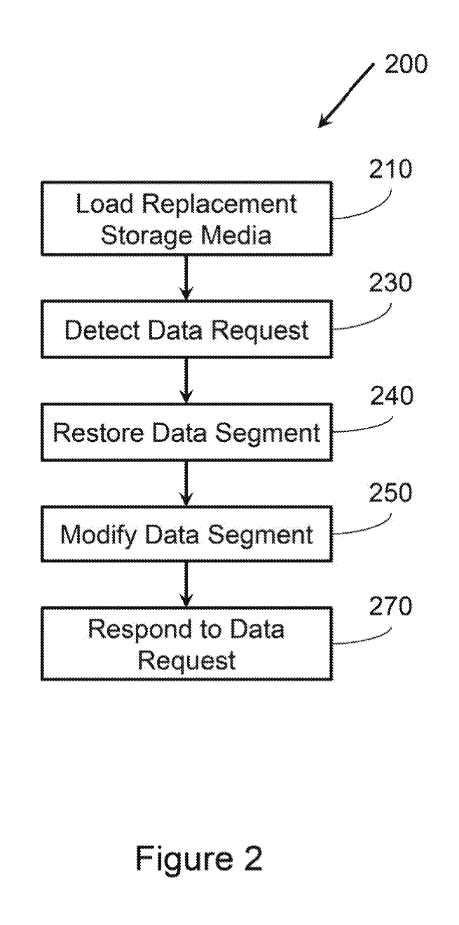

FIG. 2 illustrates an example method 200 associated with data restoration. Method 200 includes loading a replacement storage media at 210. The replacement storage media may be restored upon detecting a media failure in a failed storage media. In general, storage media may refer to hard disks, solid state drives, and so forth. Method 200 also includes detecting a data request at 230. The data request may be a result of a memory request, a SQL query, an HTTP get request, and so forth. The data request may be, for example, a read request, a write request, and so forth. The data request may be for data originally stored on the failed storage media that is now inaccessible due to the failure of the failed storage media. Additionally, the data request may be for data that is pending restoration to the replacement storage media.

Method 200 also includes restoring a data segment at 240. Typically a data segment refers to a portion of memory that is convenient and/or efficient to load and store based on a memory architecture of a system performing method 200. Many systems will likely treat a single page of memory as a data segment as a natural result of their respective architectures. However, data segment sizes larger or smaller than a page of memory may also be used. The data segment restored at 240 may contain the data requested in the data request. The data segment may be restored to the replacement storage media from a backup. The backup may include a full backup, a differential backup, an incremental backup, and so forth. Method 200 also includes modifying the data segment at 250. The data segment may be modified at 250 in the replacement storage media, or in memory before storing the data segment to the replacement storage media. The data segment may be modified at 250 according to archived modifications to the data segment in a log archive. In one example, the loading of the data segment from the backup as a part of action 240 and the modification of the data segment at 250 may occur while the data segment is in memory before the data segment is stored on the replacement storage media as a part of action 240.

Additionally, a single pass restore technique may be performed when restoring data from the backup to the replacement storage media. Thus, if backups and a log archive associated with the data segment are sorted by device identifier and page identifier, restoring the data segment at 240 and modifying the data segment at 250 may occur in a single pass over the data segment by applying all modifications to the data segment identified in the backups and log archives without removing the data segment from memory by storing the data segment. This may restore this data segment faster than fully loading a backup to the replacement storage media, then modifying the full backup according to differential and/or incremental backups, then modifying the completed backup by a log archive. Method 200 also includes responding to the request for data at 270. As conventional techniques may require the entirety of the data originally stored on the failed storage media be restored to the replacement storage media before a response is possible, selectively loading a specific data segment on an on-demand basis in response to a data request may improve response times of systems after a media failure.

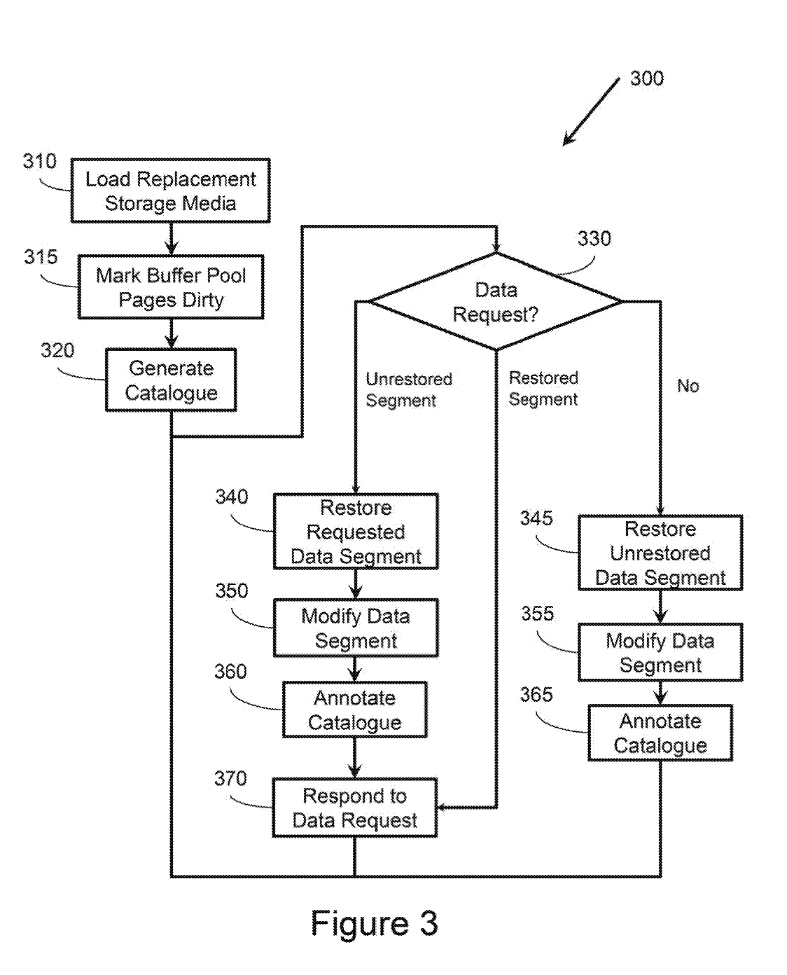

FIG. 3 illustrates an example method 300 associated with data restoration. Method 300 includes many actions similar to those described with reference to method 200 (FIG. 2 above). For example, method 300 includes loading a replacement storage media at 310, determining whether there has been a data request at 330, restoring a data segment at 340, modifying the data segment at 350, and responding to the data request at 370. Method 300 also contains additional actions. For example, method 300 includes marking a page associated with the failed storage media in a buffer pool as dirty at 315. This may ensure the page in the buffer pool is stored on the replacement storage media when a data segment with which the page is associated is written to the replacement storage media. This may also ensure that the page in the buffer pool is stored if it is evicted from the buffer pool due to, for example, the restoration process, another process needing buffer pool space, and so forth.

Method 300 also includes generating a catalogue of data segments at 320. The catalogue may be a catalogue of data segments to be restored to the replacement storage media. The catalogue may be based on information describing a set of data segments originally stored on the failed storage media.

By way of illustration, consider a database associated with users where each user is associated with their own page in the database, and where the database is divided between several devices by last name. If a media device associated with users having last names between Chang and Escobar failed, the catalogue may be generated so that each user's page has a different catalogue entry. Alternative catalogues may also be generated numerically, hierarchically, and so forth. In one example, the catalogue may be generated so that earlier entries in the catalogue are given preference for restoration over later entries assuming that there is not a pending request for a later entry. Prioritizing pages for restoration when the database is not responding to specific requests may make it more likely that a page has already been restored when a request associated with the page is received, and therefore a response to such a request may be processed more quickly. Possible reasons for prioritization may include, for example, recent use, frequent use, data importance, and so forth.

After generating the catalogue, Method 300 may proceed to determining whether there is a pending data request associated with data originally stored on the failed storage media at 330. When there is a pending data request, the catalogue of data segments may be examined to determine whether data originally stored on the failed storage media is pending restoration the replacement storage media.

When there is a pending data request, and the data request is associated with a segment that is yet to be restored to the replacement storage media, method 300 may proceed similarly to method 200 (FIG. 2), by restoring a requested segment at 340, modifying the data segment at 350, and responding to the data request at 370. In method 300, modifying the data segment at 350 may include additional actions. For example, modifying the data segment at 350 may include modifying the data segment in the replacement storage media according to modifications to the data segment noted in an active log. Modifying the data segment at 350 may also include modifying the data segment based on a page associated with the data segment that was marked as dirty in a buffer pool. As detailed above, these modifications may occur according to single pass techniques to speed up data restoration and decrease repeated load and store memory calls.

Method 300 also includes annotating the catalogue at 360. The catalogue may be annotated when the data segment has been restored to the replacement media. In this context, restoration may refer to a complete restoration of the data segment to the replacement media, including any modifications made to the data segment at action 350. However, there may be circumstances where it is appropriate to annotate the catalogue, including as soon as restoration of the data segment begins, as this may be beneficial when queuing is possible for data requests associated with data segments for which restoration is in process.

Alternatively, there may be a pending data request detected at 330 that is for data originally stored on the failed storage media that has already been restored to the replacement storage media. In this case, method 300 may proceed to action 370 and directly respond to the data request. Once the data request has been responded to at 370, whether or not the data segment had to be restored in response to the request, method 300 may return to action 330, and determine whether there is a pending data request that requires response when evaluating how to proceed with database restoration.

If there are no pending data requests detected at 330, and thus the replacement storage media would be potentially otherwise idle, method 300 may proceed to restore a next unrestored data segment at 345. The next unrestored data segment may be restored to the replacement media from the backup. The next unrestored data segment may be identified by examining the catalogue. For example, a pointer to an unrestored data segment in the catalogue may identify the next unrestored segment which may then be updated upon initiation of restoration of this segment. Upon restoring the next unrestored data segment at 345, method 300 also includes modifying the next unrestored data segment in the replacement storage media at 355. As with action 350, described above, modifying the data segment at 355 may be performed based on archived modifications to the next unrestored data segment from the log archive, modifications in the active log, pages marked as dirty in the buffer pool, and so forth. Method 300 also includes annotating the catalogue at 365 to signify that the next unrestored data segment has been restored to the replacement storage media. Upon completing restoration of this data segment, method 300 may return to action 330 to select a next course of action based on whether there is a pending data request.

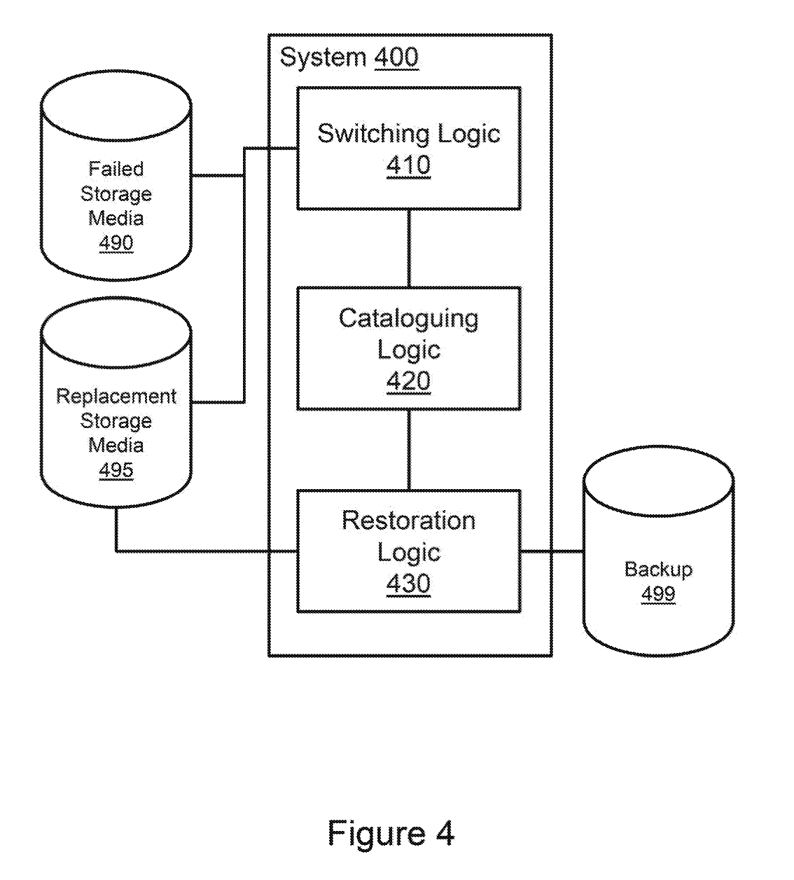

FIG. 4 illustrates an example system 400 associated with data restoration. System 400 includes a switching logic 410. Switching logic 410 may reroute data accesses directed at a failed storage media 490 to a replacement storage media 495 upon detecting a media failure in a failed storage media 490. These accesses may be rerouted, for example, via a cataloguing logic 420 and/or a restoration logic 430 to ensure that data associated with the data access has been restored to replacement storage media 495 prior to responding to the data access. Switching logic 410 may also initiate restoration of data originally stored on failed storage media 490 from a backup 499 to the replacement storage media 495. Switching logic 410 may initiate restoration, for example, by sending a signal to cataloguing logic 420. In one example, switching logic 410 may mark pages associated with the failed storage media in the buffer pool as dirty to ensure that these pages are stored to replacement storage media 495 prior to being removed from the buffer pool.

System 400 also includes cataloguing logic 420. Cataloguing logic 420 may generate a catalogue of segments originally stored on failed storage media 490. Cataloguing logic 420 may also select segments originally stored on failed storage media 490 to restore to replacement storage media 495. Cataloguing logic 420 may perform this selection based on the catalogue of segments, which segments have been restored, and whether there is a data access pending associated with an unrestored segment. As described above, selection of segments for restoration may also be based on a prioritization (e.g., recent use, frequent use).

System 400 also includes restoration logic 430. Restoration logic 430 may act in response to direction from cataloguing logic 420. Thus, cataloguing logic 420 may direct restoration logic 430 to obtain from backup 499 a segment originally stored on failed storage media 490. The restoration logic 430 may then modify the segment according to information associated with the segment stored in a log archive. The log archive may be stored, for example, on backup 499, in a memory associated with system 400, on one or more storage media that has not failed, and so forth. In one example, the backup and the log archive may be sorted according to page identification numbers. In another example, the backup and the log archive may be indexed according to page identification numbers. Restoration logic 430 may also store the segment in replacement storage media 495. To quickly load and modify and store the backup, restoration logic 430 may employ a single pass restore process when restoring segments to replacement storage media 495.

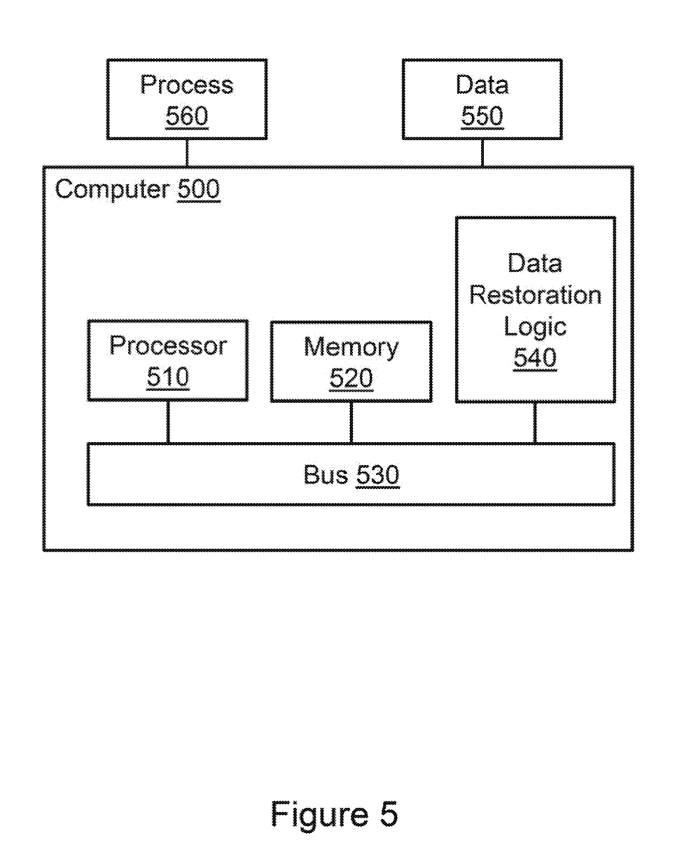

FIG. 5 illustrates an example computing environment in which example systems and methods, and equivalents, may operate. The example computing device may be a computer 500 that includes a processor 510 and a memory 520 connected by a bus 530. The computer 500 includes a data restoration logic 540. In different examples, data restoration logic 530 may be implemented as a non-transitory computer-readable medium storing computer-executable instructions in hardware, software, firmware, an application specific integrated circuit, and/or combinations thereof.

The instructions, when executed by a computer, may cause the computer to redirect data accesses associated with a failed storage media to a replacement storage media. The instructions may also cause the computer to restore a data segment from a backup associated with the failed storage media to the replacement storage media in a single pass by loading the segment from the backup and modifying the segment according to a log archive. In some cases, the segment may be prioritized for restoration because data associated with the segment is requested in a data access.

The instructions may also be presented to computer 500 as data 550 and/or process 560 that are temporarily stored in memory 520 and then executed by processor 510. The processor 510 may be a variety of various processors including dual microprocessor and other multi-processor architectures. Memory 520 may include volatile memory (e.g., read only memory) and/or non-volatile memory (e.g., random access memory). Memory 520 may also be, for example, a magnetic disk drive, a solid state disk drive, a floppy disk drive, a tape drive, a flash memory card, an optical disk, and so on. Thus, Memory 520 may store process 560 and/or data 550. Computer 500 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features closed herein.

What is claimed is:

1. A data restoration method, comprising:
loading a replacement storage media in response to detecting a media failure in a failed storage media; and
upon detecting a request for data originally stored on the storage media that is pending restoration to the replacement storage media:
restoring a data segment associated with the data from a backup to the replacement storage media,
modifying the data segment in the replacement storage media according to archived modifications to the data segment in a log archive, and
responding to the request for data.

2. The data restoration method of claim 1, further comprising:
generating a catalogue of data segments to be restored to the replacement storage media based on information describing a set of data segments originally stored on the failed storage media;
annotating the catalogue when a data segment has been restored to the replacement media; and
restoring a next unrestored data segment to the replacement storage media from the backup if the replacement storage media would be otherwise idle.

3. The data restoration method of claim 2, further comprising modifying the next unrestored data segment in the replacement storage media according to archived modifications to the next unrestored data segment in the log archive.

4. The data restoration method of claim 2, where the catalogue of data segments is examined to determine whether data originally stored on the failed storage media is pending restoration to the replacement storage media.

5. The data restoration method of claim 1, further comprising responding to a request for data upon detecting a request for data originally stored on the failed storage media that has been restored to the replacement storage media.

6. The data restoration method of claim 1, where the backup is one or more of a full backup, a differential backup, and an incremental backup, and where a single pass restore is employed when restoring data from the backup to the replacement storage media.

7. The data restoration method of claim 1, further comprising modifying the data segment in the replacement storage media according modifications to the data segment noted in n active log.

8. The data restoration method of claim 1, further comprising marking a page associated with the failed storage media in a buffer pool as dirty, to ensure the page is stored on the replacement storage media when a data segment with which the page is associated is written to the replacement storage media.

9. A system, comprising:
witching logic to, in response to detecting a media failure in a failed storage media, reroute data accesses directed at the failed storage media to a replacement storage media, and to initiate restoration of data originally stored on the failed storage media from a backup to the replacement storage media;
a catalog g logic to generate a catalogue of segments originally stored on the failed storage media, and to select segments originally stored on the failed storage media to restore to the replacement storage media based on the catalogue of segments, which segments have been restored, and whether there is a data access pending associated with an unrestored segment; and
a restoration logic to, in response to a direction from the cataloguing logic, obtain from the backup a segment originally stored on the failed storage media, to modify the segment according to information associated with the segment stored in a log archive, and to store the segment in the replacement storage media.

10. The system of claim 9, where the backup and the log archive are one of: sorted according to page identification numbers, and indexed according to page identification numbers.

11. The system of claim 10, where the restoration logic employ a single pass restore process when restoring segments.

12. The system of claim 9, where the switcher marks pages associated with the failed storage media in the buffer pool as dirty.

13. A non-transitory computer-readable medium storing computer-executable instructions that when executed by a computer cause the computer to redirect data accesses associated with a failed storage media to a replacement storage media; and
restore a data segment from a backup associated with the failed storage media to the replacement storage media in a single pass by loading the segment from the backup and modifying the segment according to a log archive,
where the segment is prioritized for restoration because data associated with the segment is requested in a data access.
